(19) United States
(12) Patent Application Publication
(10) Pub. No.: US 2020/0259795 A1
(43) Pub. Date: Aug. 13, 2020

(54) AUTOMATIC VPN ESTABLISHMENT WITH SPLIT TUNNEL FOR REMOTE RESOURCES

(71) Applicant: COLORTOKENS, INC., Santa Clara, CA (US)

(72) Inventors: ARUN KOSHAL, Khurja (IN); Vishal Sharma, Ghaziabad (IN); Raghavendra Thantradi Nagappa, Bangalore (IN); Sagar Singha, Bangalore (IN)

(21) Appl. No.: 16/270,603

(22) Filed: Feb. 8, 2019

(51) Int. Cl. H04L 29/06; H04L 12/46; H04L 12/24

(52) U.S. Cl. CPC H04L 63/0272; H04L 41/0806; H04L 12/4641

(57) ABSTRACT

A method and system to automatically access one or more resources for a device at a remote location has been described. Initially a determination is made whether the device is at the remote location. Based on a domain configuration including one or more domains accessible to the device at the remote location, a VPN adapter is generated at the device in the remote location. A route is automatically determined from the VPN adapter to the one or more resources, corresponding to the accessible domains, within a corporate network. Finally the one or more resources are accessed within the corporate network from the device at the remote location using the determined route.

### BACKGROUND

Currently, work-from-the-home and Bring your own device (BYOD) has become very popular in all companies. This requires a user to access corporate resources from a remote location. Virtual Private Networks (VPNs) (IP Sec and TLS) are currently being extensively used to enable users to access enterprise resources remotely. One of the main issues with VPN access is that a remote resource has to manually try to access enterprise network using the proprietary VPN client. In order to provide a better experience to a user, the process of accessing the VPN network should be seamless. Further, the effort for adding the enterprise domains (whose traffic will go via the enterprise network) at remote resource should be minimal (zero-touch).

Additionally, VPN products provide network access to the remote resources and when a remote device establishes a connection with enterprise VPN gateway, the device becomes part of the enterprise network, which is not desirable from security perspective. Ideally the remote user should not have access to the enterprise network but still, should be able to access the enterprise application servers using domain name. Only the traffic destined to enterprise network applications should be forwarded to the enterprise network, rest of the traffic should be directly forwarded to Internet.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating an exemplary network environment to remotely access a resource within a corporate network, according to an embodiment.

FIG. 2 is a detailed block diagram illustrating a network environment to generate a VPN adapter to access one or more resources within the network, according to an embodiment.

FIG. 3 is a flow diagram illustrating a process to automatically access one or more resources within a corporate network, according to an embodiment.

### DETAILED DESCRIPTION

Embodiments of techniques of automatic VPN establishment with split tunnel for remote resources are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

An enterprise network is an enterprise's communications backbone that helps connect computers and related devices across departments and workgroup networks, facilitating insight and data accessibility. A device, for example, a user within an enterprise network has access rights to access the different resources, for example, data servers, web portals, etc., within the enterprise network. When a user is outside the enterprise network then it has to use Virtual Private Network (VPN) to access the resources within the corporate network. VPN is an acronym for Virtual Private Network that provides a way to create an encrypted “tunnel” across the internet that allowed secure data transmission

In order to access the device from remote location, without user intervention, the present invention proposes auto-detecting user's remote location, i.e., whether the user is outside the corporate network. A user may be using another internet network to request access to one or more resources within the corporate network.

Whenever, the user is outside the network, a virtual private network (VPN) connection is established that allows a user to access the corporate resources. In one embodiment, the user may be allowed access to only limited resources within the corporate network. In order to allow a user access to only allowed resources a configuration that includes the list of accessible domains is provided to the device. The device creates a VPN adapter based on the received configuration that provides the device access to the accessible resources within the corporate network. A domain is a distinct subset of the internet with addresses sharing a common suffix or under the control of a particular organization or individual. For example, .edu is a domain name of resources related to education websites. Allowing a user access to the corporate resources based on auto-generation of the VPN connection, solves the various problems related to remote access of corporate resources.

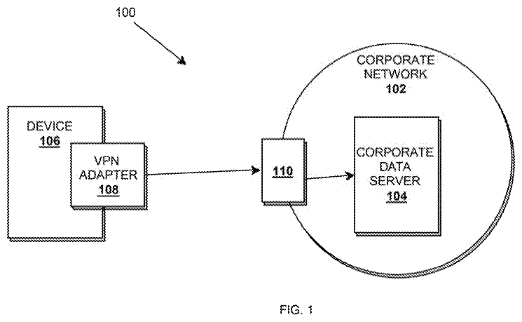

FIG. 1 is a block diagram illustrating an exemplary network environment 100 to remotely access a resource within a corporate network, according to an embodiment. As shown a corporate network 102 may have one or more resources, for example a corporate data server 104. A user's device 106, depending on user's access level, is configured in the corporate network as a legitimate user that is configured to access the data server 104. The user's device 106 may access the corporate data server 104 when the device 106 is within the corporate network 102.

When the device 106 moves outside the corporate network, i.e., at a remote location then the user may connect with a home or some other network. The device 106 connected to home or some other network tries to connect to the corporate network 102. The device 106 connected to the home or some other network tries to access the corporate data server 104 within the corporate network 102.

When the device 106 detects that it is at a remote location, outside the network 102, then it creates a VPN adapter 108. A VPN adapter 108 is a software component that allows communication over VPN with another network. The VPN adapter 108 connects with a Corporate VPN gateway 110. The established channel is used to establish a communication between the device 106 and the corporate data server 104.

By split tunnelling, the device 106 can also access a public resource by directly connecting to internet without going through the VPN gateway. Therefore, the device 106 traffic for the corporate configured domains is going via the established communication between the VPN adapter 108 and the corporate VPN gateway 110 and traffic other than configured domains goes directly via the home or some other network.

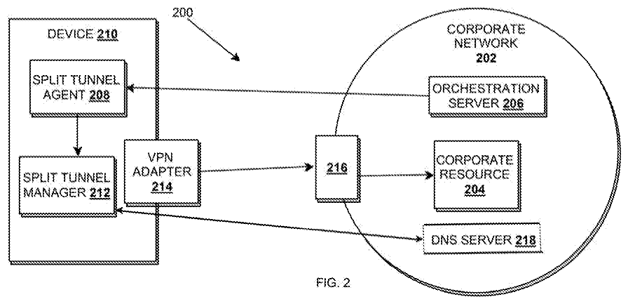

FIG. 2 is a detailed block diagram illustrating a network environment 200 to create a VPN adapter to access one or more resources within the network, according to an embodiment. The network environment 200 includes a corporate network 202 that has one or more corporate resources 204. The corporate network 202 includes an orchestration server 206 on which the administrator configures the domain list. The domain configuration received from the administrator includes the different domains that the user is allowed to access within the corporate network.

The orchestration server 206 pushes the domain configuration to a split tunnel agent 208 at a device 210. The split tunnel agent 208 is a thin component which runs on user devices, for example device 210. The orchestrator server 206 communicates with this split tunnel agent 208 to download split tunnel configuration and further store the domain configuration on the device 210. The orchestration server 206 is also responsible to update the split-tunnel configuration at the split tunnel agent 208 in case of changes done by an administrator at the server 206.

The device 208 also includes a split tunnel manager 212 that receives the domain configuration from the split tunnel agent 208. The split tunnel manager 212 that receives the domain configuration creates a VPN adapter 214 based on the received domain configuration.

The domain configuration indicates the domains that the user is allowed to access. In one embodiment, the split tunnel manager 212 sends a DNS query to corporate DNS server 218 to check whether the device is within the corporate network. When the DNS query fails then the split tunnel manager determines that the device is outside the corporate network. Based on the detection, the split tunnel manager 212 creates a VPN adapter 214. The split tunnel manager 212 then sends DNS queries for the corporate resource 204 domain name to corporate DNS server 218 via the VPN adapter 214.

Based on the DNS query for corporate resource 204 domain name, the corporate DNS server sends an IP address of the corporate resource 204. Next the split tunnel manager 212 adds a route for the IP address of the corporate resource 204 to forward the traffic destined to the corporate resource 204 via VPN adapter 214 and VPN gateway 216. The traffic destined to public network is sent directly to the public network and is not sent via the VPN adapter 214.

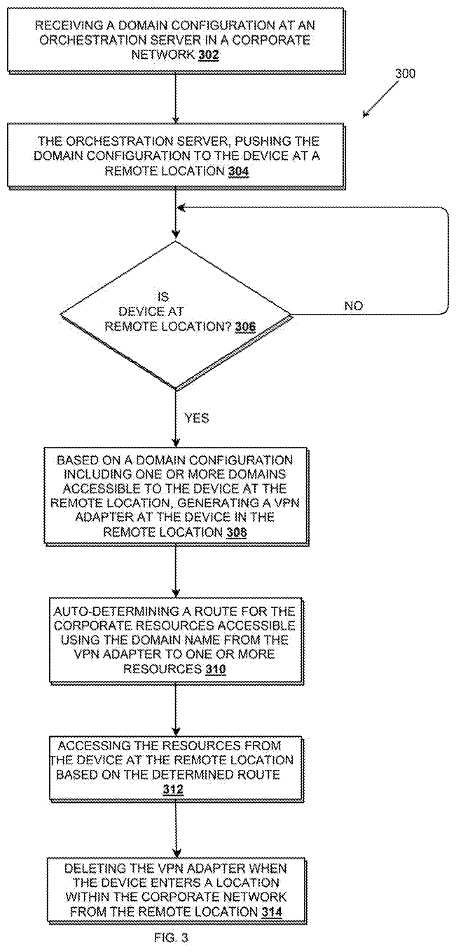

FIG. 3 is a flow diagram 300 illustrating a process to automatically access one or more resources within a corporate network, according to an embodiment. Initially a domain configuration is received at an orchestration server in a corporate network (302). Next the domain configuration is pushed by the orchestration server to the device (304). In one embodiment, the domain configuration is pushed to the split tunnel agent that transfers it to split tunnel manager.

Next a determination is made whether the device is at a remote location (306). The device location is determined based on DNS query send to the corporate DNS server by the split tunnel manager. Next in case the device location is at the remote location then a VPN adapter is created at the device based on the domain configuration including one or more domain accessible to the device (308). Next a route is auto-determined for the corporate resources accessible using the domain name from the VPN adapter to the one or more resources, corresponding to the accessible domains, within the corporate network (310).

Next the device is able to access the corporate resource based on the determined route (312). Finally, whenever the device enters a location within the corporate network then the VPN adapter is deleted (314).

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitory, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide fir interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to automatically access one or more resources from a device at a remote location, the computer implemented method comprising:
detecting whether the device is at the remote location;
based on a domain configuration including one or more domains accessible to the device at the remote location, generating a VPN adapter at the device in the remote location;
automatically determining a route from the VPN adapter to the one or more resources, corresponding to the accessible domains, within a corporate network; and
accessing the one or more resources within the corporate network from the device at the remote location using the determined route.

2. The computer implemented method according to claim 1, further comprising:
auto-deleting the VPN connection when the device enters a location within the corporate network from the remote location.

3. The computer implemented method according to claim 1, further comprising:
pushing the domain configuration from an orchestration server within the corporate network to the device at the remote location.

4. The computer implemented method according to claim 1, further comprising:
accessing a non-corporate resource directly via a direct connection excluding the determined route.

5. The computer implemented method according to claim 1, further comprising:
receiving the domain configuration at the orchestration server.

6. The computer implemented method according to claim 1, wherein auto determining a route comprises:
determining a route from the VPN adapter to a VPN end point within the corporate network.

7. The computer implemented method according to claim 1, further comprising:
auto-updating the configuration information at the device.

8. A computer system to automatically establish Virtual Private Network (VPN) connection with split tunnel for a device in a remote location, the system comprising:
a memory storing instructions; and
a processor executing the stored instructions to:
detect whether the device is at the remote location;
based on a domain configuration including one or more domains accessible to the device at the remote location, generate a VPN adapter at the device in the remote location;
automatically determine a route from the VPN adapter to the one or more resources, corresponding to the accessible domains, within a corporate network; and
access the one or more resources within the corporate network from the device at the remote location using the determined route.

9. The computer system of claim 8, wherein the processor further executes the instructions to:
auto-delete the VPN connection when the device enters a location within the corporate network from the remote location.

10. The computer system of claim 8, wherein the processor further executes the instructions to:
push the domain configuration by an orchestration server within the corporate network to the device at the remote location.

11. The computer system of claim 8, wherein the processor further executes the instructions to:
access a non-corporate resource directly via a direct connection excluding the determined route.

12. The computer system of claim 8, wherein the processor further executes the instructions to:
receive the domain configuration at the orchestration server.

13. The computer system of claim 8, wherein the processor further executes the instructions to:
determine a route from the VPN adapter to a VPN end point within the corporate network.

14. The computer system of claim 8, wherein the processor further executes the instructions to:
auto-update the configuration information at the device.

15. A non-transitory computer-readable medium to store instructions, which when executed by a computer, cause the computer to perform operations comprising:
detect whether the device is at the remote location;
based on a domain configuration including one or more domains accessible to the device at the remote location, generate a VPN adapter at the device in the remote location;
automatically determine a route from the VPN adapter to the one or more corporate resources, corresponding to the accessible domains, within a corporate network; and
access the one or more resources within the corporate network from the device at the remote location using the determined route.

16. The computer-readable medium of claim 15, further comprises instructions which when executed by the computer further cause the computer to:
auto-delete the VPN connection when the device enters a location within the corporate network from the remote location.

17. The computer-readable medium of claim 15, further comprises instructions which when executed by the computer further cause the computer to:
push the domain configuration by an orchestration server within the corporate network to the device at the remote location.

18. The computer-readable medium of claim 15, further comprises instructions which when executed by the computer further cause the computer to:
access a non-corporate resource directly via a direct connection excluding the determined route.

19. The computer-readable medium of claim 15, further comprises instructions which when executed by the computer further cause the computer to:
receive the domain configuration at the orchestration server.

20. The computer-readable medium of claim 15, further comprises instructions which when executed by the computer further cause the computer to:
determine a route from the VPN adapter to a VPN end point within the corporate network.
